(19) United States
(12) Patent Application Publication
(10) Pub. No.: US 2015/0107247 A1
(43) Pub. Date: Apr. 23, 2015

(54) CONTROL SYSTEM FOR OXY FIRED POWER GENERATION AND METHOD OF OPERATING THE SAME

(71) Applicant: ALSTOM Technology Ltd, Baden (CH)

(72) Inventors: Xinsheng LOU, West Hartford, CT (US); Shizhong YANG, Bloomfield, CT (US)

(73) Assignee: ALSTOM Technology Ltd, Baden (CH)

(21) Appl. No.: 14/057,769

(22) Filed: Oct. 18, 2013

(51) Int. Cl. F01K 13/02; G05B 15/02; F01K 11/02

(52) U.S. Cl. CPC F01K 13/02; F01K 11/02; G05B 15/02
USPC 60/645; 60/667; 700/287

(57) ABSTRACT

A method of operating an electricity production system having at least one oxy-combustion boiler unit and a turbine for electricity generation at least includes the steps of: determining a power demand for an air separation unit that supplies oxygen gas to the boiler unit and a gas processing unit that treats flows of fluid for CO₂ capture; determining a total power demand for electricity production that includes the determined power demand for the air separation unit and the gas processing unit; and coordinating operation of the air separation unit, gas processing unit, the boiler unit, and the turbine such that power generated by the plant provides power that meets the determined total power demand and also controls steam pressure of the turbine to a pre-specified level.

### FIELD

The present disclosure relates to a power generation system and method of utilizing such a system. Embodiments of the power generation system may utilize at least one oxy-fired boiler unit, at least one steam turbine unit, at least one air separation unit, at least one gas processing unit, and a control system for such a production system, and methods of operating the same.

### BACKGROUND

Energy production systems that burn coal to produce power may include a boiler and a steam turbine. Energy production systems that are utilized in electricity production and other components of such systems are described, for example, in U.S. Patent Application Publication Nos. 2012/0052450, 2012/0145052, 2010/0236500, and 2009/0133611 and U.S. Pat. Nos. 7,954,458 and 6,505,567.

Oxy-combustion is a development for carbon dioxide capture and sequestration in fossil fuel (e.g. coal, etc.) fired power plants to replace combustion air with a mixture of oxygen and recycled flue gas to create a high carbon dioxide content flue gas stream that can be more easily processed for sequestration. In U.S. Patent Application Publication No. 2012/0145052, it is disclosed that some oxy-combustion systems may include an air separation unit, a boiler, an air pollution control system, and a gas processing unit for carbon dioxide capture. The heat from the flue gas of the boiler may be captured by the steam, which is then used to drive a steam turbine generator to produce electricity. The flue gas may then be processed to remove certain pollutants (e.g. NOₓ, SOₓ, etc.) with an air pollution control system. A portion of the treated flue gas may then be recycled to the boiler to effect combustion and a remaining portion may be fed to a gas processing unit for carbon dioxide capture.

### SUMMARY

A method of operating an electricity production system having at least one oxy-combustion boiler unit and a turbine for electricity generation may include the steps of determining a power demand for an air separation unit that supplies oxygen gas to the boiler unit and a gas processing unit that treats flows of fluid for carbon dioxide capture, determining a total power demand for electricity production that includes the determined power demand for the air separation unit and the gas processing unit, and coordinating operation of the air separation unit, the gas processing unit, the boiler unit, and the turbine such that power generated by the turbine provides power that meets the determined total power demand and also controls steam pressure of the turbine to a pre-specified level.

A control system for an electricity production system having at least one oxy-combustion boiler unit and a turbine for electricity generation can include a load management control having non-transitory memory and at least one processor communicatively connected to the memory and a unit master station having non-transitory memory and at least one processor communicatively connected to the memory. The unit master station may be communicatively connected to the load management control and may be configured to be communicatively connectable to an air separation unit control that controls an air separation unit, a boiler control system that controls the boiler unit, and a turbine control system that controls the turbine. The load management control can be configured for determining an initial power demand that is supplemented by adding additional power demand for the air separation unit and a gas processing unit to determine a total power demand. The unit master station may also be configured for determining a demand for the boiler unit, turbine, gas processing unit and air separation unit based on actual power generation, total power demand, an actual pressure of a throttle of the turbine and a pre-specified set point for the pressure of the throttle of the turbine for communicating operational controls to at least the air separation unit control system, boiler control system, and turbine control system.

An electricity production system may include an oxy-combustion boiler unit, a turbine for receiving steam from the boiler unit, an air separation unit for feeding oxygen gas separated from air to the boiler unit for combustion of fuel in the boiler unit to form steam that is to be fed to the turbine, a gas processing unit for processing the flue gas from the boiler unit to capture carbon dioxide, and a control system including a load management control and a unit master station. The load management control may have non-transitory memory and at least one processor communicatively connected to the memory. The unit master station may have non-transitory memory and at least one processor communicatively connected to the memory. The unit master station can be communicatively connected to the load management control and may be communicatively connectable to an air separation unit control system that controls the air separation unit, a gas processing unit control system that controls the gas processing unit, a boiler control system that controls the boiler unit, and a turbine control system that controls the turbine. The load management control may be configured for determining an initial power demand that is supplemented by adding additional power demand for the air separation unit and a gas processing unit to determine a total power demand. The unit master station may be configured for determining demands for all subsystems based on the total power demand, a determined power generation, a determined pressure of a throttle of the turbine and a pre-specified set point for the pressure of the throttle of the turbine for communicating operational controls to at least the air separation unit control system, gas processing unit control system, boiler control system, and turbine control system.

### BRIEF DESCRIPTION OF THE DRAWINGS

Exemplary embodiments of electricity production systems and associated exemplary methods are shown in the accompanying drawings. It should be understood that like reference numbers used in the drawings may identify like components, wherein:

FIG. 1 is a block diagram of an exemplary embodiment of an energy production system.

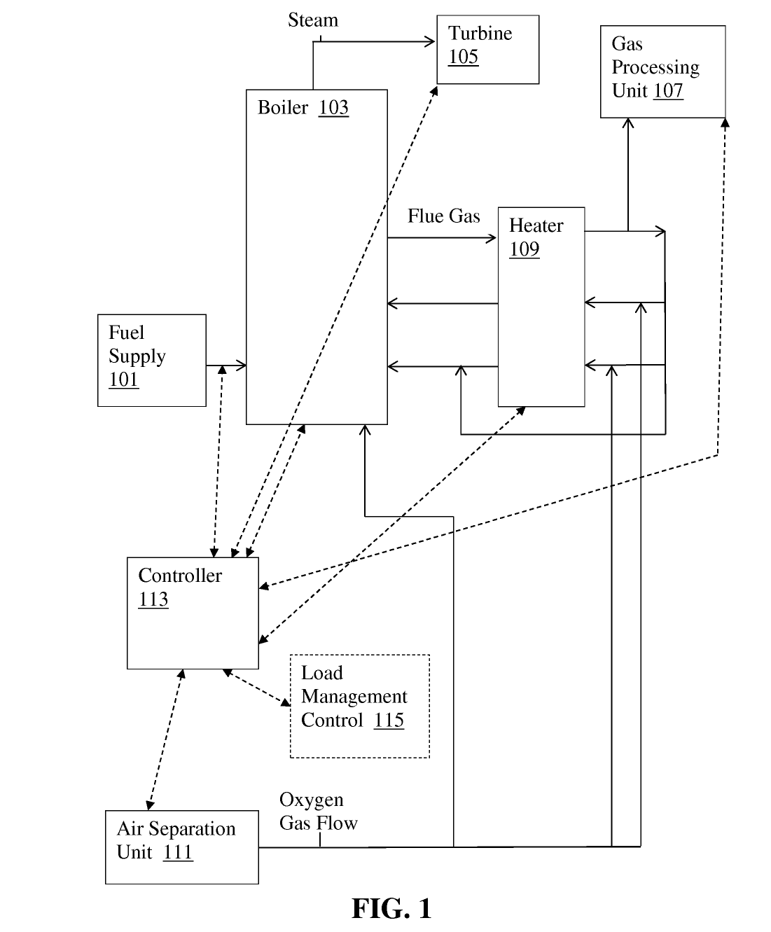

FIG. 2 is a flow chart illustrating an exemplary method of operating an energy production system.

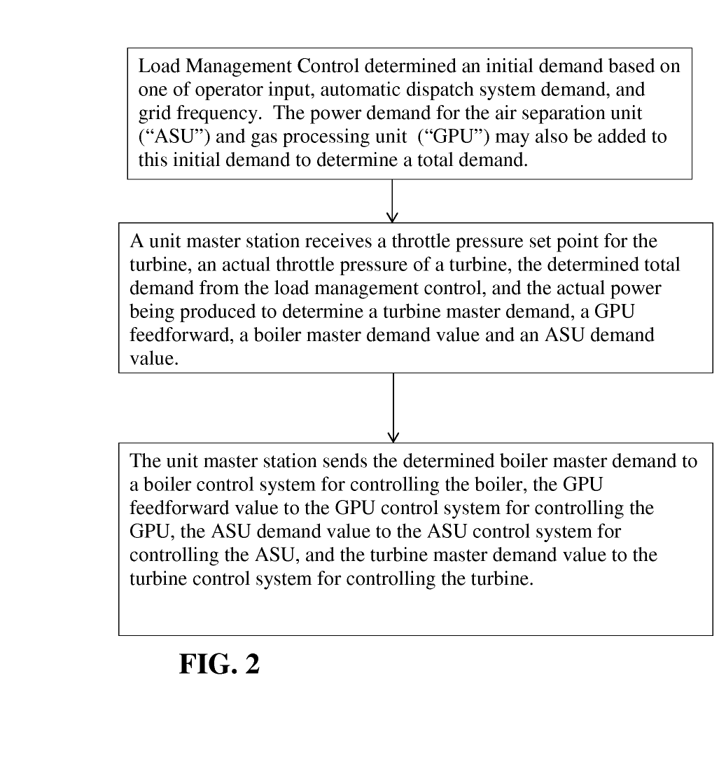

FIG. 3 is a flow chart illustrating an exemplary method determining a total amount of power at which an energy production system may operate.

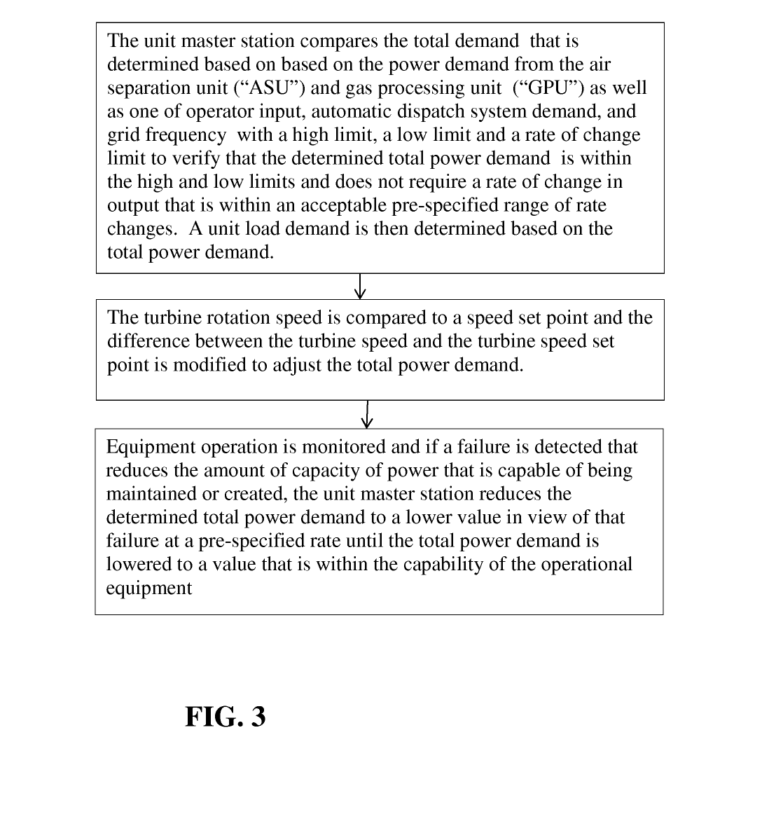

FIG. 4 is a flow chart illustrating an exemplary method of operating an energy production system in any of three different selectable modes.

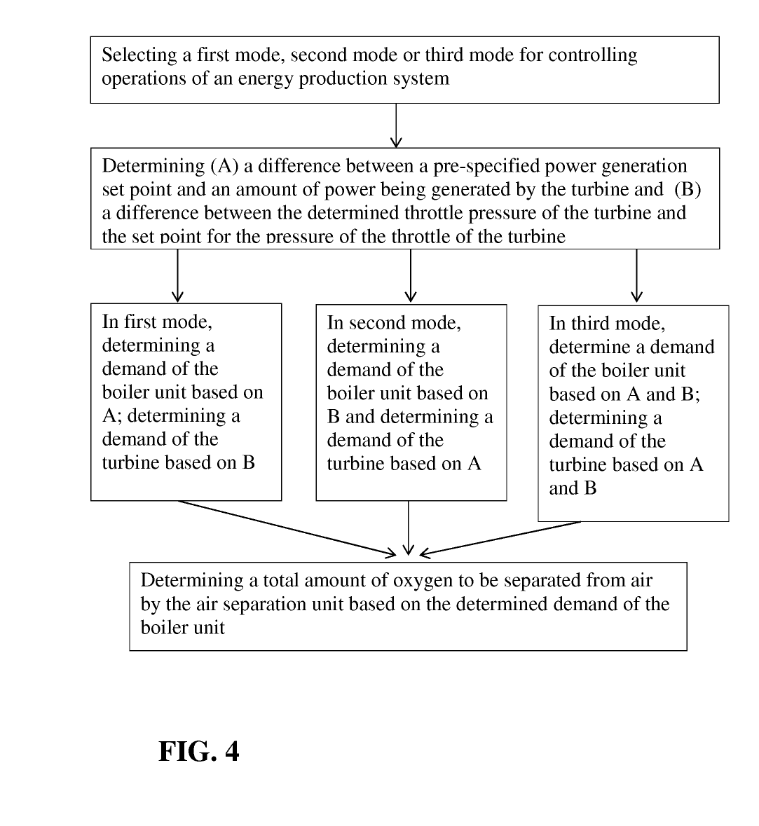

Other details, objects, and advantages of embodiments of the innovations disclosed herein will become apparent from the following description of exemplary embodiments and associated exemplary methods.

### DETAILED DESCRIPTION

Applicants have discovered that operations of an oxy-fired boiler and turbine can be coordinated with operations of a gas processing unit and air separation unit to provide an improvement in plant efficiency and operating flexibility, and reducing carbon emissions. Exemplary energy production systems and methods of operating such systems, as disclosed herein, can also permit operation of the system to comply with applicable government regulations to produce electrical power with a relatively low carbon footprint.

An electricity production system may include a fuel supply 101 that feeds fuel, such as pulverized coal, to a boiler 103 of a boiler unit. The boiler 103 may include a furnace in which fuel is combusted to form a flue gas that comprises products of the combusted fuel, such as nitrous oxides (NOₓ), carbon dioxide (CO₂), and carbon monoxide (CO). The boiler 103 may be an oxy-fired boiler unit that emits flue gas that includes the combustion products. The heat release from combustion is absorbed by water and is turned into a high temperature and high pressure stream. Such steam may be fed to the steam turbine 105 to drive a power generator for electricity generation. Flue gas emitted by the boiler 103 may be fed to a series of air pollution control systems for cleaning certain pollutants such as sulfur oxides and nitrous oxide components of the flue gas. After cleaning, one portion of the flue gas may be recycled back to the boiler 103 and a remaining portion of the flue gas emitted by the boiler 103 may be fed to a gas processing unit (“GPU”) 107 for CO₂ capture, or carbon capture. An air separation unit (“ASU”) 111 may separate oxygen from air for feeding oxygen to the boiler and to the recycled flue gas prior to being fed to the heater 109. The boiler 103 may then combust fuel based on the oxygen and other components within the recycled flue gas fed to the boiler 103. A controller 113 may be communicatively connected to the fuel supply 101, boiler 103, the turbine 105, the GPU 107, the heater 109, the ASU 111 and valves and other conduit components through which oxygen gas, flue gas, or fuel pass for communicating to those elements of the system.

The ASU 111 may be configured to feed separated oxygen gas to one or more storage units or vessels. The oxygen gas separated by the ASU may then subsequently be fed via the oxygen gas stored in the one or more storage units. The controller 113 may also be communicatively connected to the storage units to detect a capacity of oxygen stored therein for use in assessing ASU load demand. For instance, ASU load demand may be determined by the state of storage, the power grid electricity price and MW availability (e.g. electricity generation capacity). In some embodiments, at least a minimum load level may be maintained at all times to keep the ASU 111 and GPU 107 in operation while zero net electricity is supplied to the power grid.

The controller 113 may include at least one non-transitory memory and at least one processor. The controller may also include at least one transceiver for communicating with the boiler 103, turbine 105, GPU 107, heater 109, ASU 111 and elements of the conduit (e.g. valves, tanks, oxygen storage vessels, etc.). For example, the memory may be flash memory, a hard drive, or other non-transitory memory that is computer readable and may have an application stored thereon that defines instructions that are executed by the processor running that application. A processor may be a hardware element such as a microprocessor, multiple interconnected microprocessors, or other type of hardware processor element. In one embodiment, the memory may be flash memory and the processor may be a Pentium® processor made by Intel Corporation. In some embodiments, the controller 113 may be a unit master station, a computer, a workstation, a server, a controller, a programmable logic controller, or other type of computer device.

The electricity production system may be operated by determining a power demand for the ASU 111 that supplies oxygen gas to the boiler 103 and the GPU 107 that treats flows of flue gas for CO₂ capture. A total power demand for electricity production may then be determined that includes the determined power demand for the ASU 111 and GPU 107. The operation of the ASU 111, GPU 107, the boiler 103, and the turbine 105 may be coordinated such that power generated by the electricity production system provides power that meets the determined total power demand and also controls steam pressure of the turbine to a pre-specified level, such as, for example, a turbine pressure set point.

The controller 113 may determine the total power demand for electricity production that includes the determined power demand for the ASU 111 and the GPU 107. For instance, the controller can determine one of a value from operator input, grid frequency, and an automatic dispatch demand to identify a first load amount. The controller 113 may subsequently verify that the first load amount is below a first limit, which may be a high limit, and is greater than a second limit, which may be a low limit that is lower than the first limit. The controller 113 may then verify that the first load amount corresponds to a rate change that is within a pre-specified unit load rate limit.

In other embodiments, the controller 113 may communicate with a load management control 115 to determine an initial power demand that is based on operator input, grid frequency, and an automatic dispatch demand so that the load management control 115 identifies the initial power demand to the controller 113. The controller 113 may then supplement the initial power demand identified by the load management control 115 with power demands for the ASU 111 and GPU 107.

As another alternative, the load management control 115 may determine the initial power demand and also supplement that demand with the power demands for the ASU 111 and GPU 107 to determine a total power demand. The load management control 115 may subsequently send a message containing data to identify a total demand to the controller 113 or may send a signal to the controller 113 to identify a total demand to the controller 113.

It should be appreciated that the load management control 115 may be a computer device such as a computer, a workstation, a server, a controller, a programmable logic controller, or other type of computer device. The load management control 115 may include at least one non-transitory memory and at least one processor. The load management control 115 may also include at least one transceiver for communicating with the controller 113. For example, the memory may be flash memory, a hard drive, or other non-transitory memory that is computer readable and may have an application stored thereon that defines instructions that are executed by the processor running that application. The processor may be a hardware element such as a microprocessor, multiple interconnected microprocessors, or other type of hardware processor element. In one embodiment, the memory may be flash memory and the processor may be a Pentium® processor made by Intel Corporation.

The controller 113 may also determine a difference between a turbine rotational speed set point and a measured rotational speed of the turbine. The controller 113 may receive data from the turbine or sensors connected to the turbine that provide such data or provide measurements by which the controller determines the measured rotational speed of the turbine 105. The controller 113 may also add a value corresponding to the difference between the turbine rotational speed set point and the measured rotational speed of the turbine to an initial power demand amount based on operator input, grid frequency, or automatic dispatch system demand when that amount is below the first limit, greater than the second limit and corresponds to the rate change that is within the pre-specified unit load rate limit to adjust the determined initial power demand value to account for differences in turbine operational settings and measured operations to identify an amount of power to be added to the determined power demand for the ASU 111 and the GPU 107 to determine the total power demand. The controller 113 may also verify that the determined total power demand is less than a maximum amount of power that is produceable by the system to prevent the controller from placing the system in an operational state to meet a demand that the system cannot meet.

The energy production system may be configured to coordinate operations of the different elements of the system. In some embodiments, the system may be configured so that it can operate in different modes. For instance, the system may be configured to operate in any of a boiler following mode, a turbine following mode, and a coordinated control mode, for the coordinating operation of the ASU 111, the GPU 107, the boiler 103, and the turbine 105 based on coordinated turbine pressure control and desired power generation.

In the boiler following mode, the controller 113 may be configured to coordinate operation of the ASU 111, GPU 107, boiler 103 and turbine 105. For instance, the controller 113 may determine a turbine master demand to meet the total power generation demand. The controller 113 may also determine the boiler master demand to control a throttle pressure of the turbine 105 adjacent an inlet at which steam may be fed to the turbine 105.

The controller 113 may also determine the boiler master demand to control an operational pressure of the steam turbine 105. Such determinations may be made by receiving data from sensors or detectors positioned adjacent a valve or other element of a conduit through which steam and other fluid is fed to the turbine and by communication with sensors or other detectors positioned in or adjacent the turbine that collect data for monitoring the pressure of the turbine and conduits at which fluid is fed to the turbine and emitted from the turbine. The controller 113 may also determine a difference between the operational pressure of the turbine and the pressure set point for the turbine and determine a demand of the boiler unit based upon the determined loading pressure, operational pressure, and the difference between the operational pressure of the turbine and the pressure set point. A total amount of oxygen to be separated from air by the ASU 111 based on the determined boiler master demand may then be determined by the controller 113. Once such determinations are made by the controller 113, the controller 113 may send control signals to a control system for the GPU 107, a control system for the ASU 111, a control system for the boiler 103 and a control system for the turbine 105 to adjust operational parameters related to the operation of these elements so that the ASU 111 and/or oxygen storage tanks of the ASU 111 that receive and retain oxygen gas from the ASU 111 provides sufficient oxygen gas to the boiler so that the boiler 103 is able to burn sufficient fuel to generate steam to meet the determined demand for steam and permit the turbine to operate at the desired pressure set point for generating sufficient electricity to meet the determined total demand for electricity. For instance, the controller 113 may send a first message to the boiler control system that controls operations of the boiler 103, send a second message to an ASU control system that controls operations of the ASU 111, sending a third message to a GPU control system that controls operations of the GPU 107, and send a fourth message a turbine control system that controls operation of the turbine 105. The first, second, third and fourth messages may be signals or other electronic messages that contain data that can identify changes to operational parameters to meet the determined total power demand as well as control the pressure of the turbine.

In one exemplary embodiment, the controller 113 may be configured to control and coordinate operations of the boiler 103, steam turbine 105, GPU 107 and ASU 111 in boiler following mode by dividing the turbine first stage pressure by the steam turbine throttle pressure and multiplying the quotient of that division by the turbine throttle pressure set point (e.g. (P_{1st stage}/Pₜₕᵣₒₜₜₗₑ)*Pₛₑₜₚₒᵢₙₜ) This product may then be modified by a controller that acts on the difference between the turbine pressure and turbine pressure set point. For instance, the difference between the turbine throttle pressure and turbine throttle pressure set point may then be determined and an output value of a controller that acts on this difference may be added to the product to correct that value for a change that exists between the measured operation and the set point of the turbine. That value may then be used by the controller 113 to determine a total demand for the boiler 103 and an oxygen demand for the ASU 111.

In the turbine following mode, the controller 113 may be configured so that it determines the turbine master demand based on a difference between the throttle pressure of the turbine 105 and the throttle pressure set point of the turbine 105. The controller 113 may also determine a demand of the boiler 103 based on the determined demand of power to be generated by the plant, or electricity production system, and determine an amount of oxygen to be separated from air by the ASU 111 based on the determined demand of power to be generated by the turbine. Once such determinations are made by the controller 113, the controller 113 may send control messages to the control system for the GPU 107, the control system for the ASU 111, the control system for the boiler 103 and the control system for the steam turbine 105 to adjust operational parameters related to the operation of these elements so that the ASU 111 provides sufficient oxygen gas to the boiler so that the boiler 103 is able to burn sufficient fuel to generate steam to meet the determined demand for steam and permit the steam turbine 105 to operate at the desired pressure set point for causing a generator to generate sufficient electricity to meet the determined total demand for electricity.

In one exemplary embodiment, the controller 113 may be configured to control and coordinate operations of the boiler 103, steam turbine 105, GPU 107 and ASU 111 in turbine following mode by determining a turbine master demand based on the difference between the set point of pressure for the steam turbine and the measured pressure of the steam turbine. The amount of steam to be generated by the boiler and the amount of oxygen from the ASU 111 that is needed to generate this steam may then be determined by the controller 113. Such data may be used by the controller to send control messages to the turbine 105, boiler 103, ASU 111 and GPU 107 to meet the needs of the turbine to operate at the pressure set point of the turbine.

In the coordinated control mode, the controller 113 may be configured to determine a difference between a pre-specified power generation set point and an amount of power being generated by the plant, determine a difference between pressure adjacent an inlet of the turbine 105 and the pre-specified level of pressure for the turbine 105, and determine a demand of the boiler 103 based on the determined difference between pressure adjacent an inlet of the turbine 105 and the pre-specified level of pressure for the turbine 105 and (ii) the determined difference between the pre-specified power generation set point and the amount of power being generated by the turbine 105. The controller 113 may also determine a demand of the turbine 105 based on the determined difference between pressure adjacent an inlet of the turbine 105 and the pre-specified level of pressure for the turbine 105 and the determined difference between the pre-specified power generation set point and the amount of power being generated by the electricity production system. A total amount of oxygen to be separated from air by the ASU 111 may also be determined by the controller 113 based on the determined demand of the boiler 103.

In one exemplary embodiment, the controller 113 may be configured to control and coordinate operations of the boiler 103, steam turbine 105, GPU 107 and ASU 111 in coordinated control mode by determining a difference between a pre-specified power generation set point and an amount of power being generated by the plant. The controller 113 may add that difference to a value corresponding to a difference between the turbine operational pressure set point and the measured pressure of the turbine and add a value corresponding to that sum with a value corresponding to the power generation set point. That value may be used to control operation of the turbine.

Further, a value corresponding to the determined difference between a pre-specified power generation set point and an amount of power being generated by the plant may also be added to a value corresponding to the difference between the pressure of the steam turbine and the pressure set point for the turbine. That sum may be added to a value corresponding to the energy production set point for identifying a total amount of steam needed from the boiler. The amount of steam to be generated by the boiler and oxygen needed from the ASU 111 may then be determined for determining operational parameters for the boiler 103 and ASU 111.

A feedforward to the GPU 107 may also be based on the power generation set point. A value corresponding to the power set point may be the feedfoward for the GPU 107, for example. The controller 113 may send a signal or message to the GPU 107 that contains data for causing an adjustment to GPU operations based on this feedfoward value.

The controller 113 may also be configured to communicate with sensors, detectors, and equipment to detect an equipment failure. Upon determining that an equipment failure occurred, the controller 113 may determine whether the equipment failure prevents the system from meeting a current demand so that a change to the determined demand takes place to reduce the output of the system in response to the failure. Such a change can be a safety precaution and prevent the system from operating beyond capacity or creating a dangerous condition from occurring. For instance, the controller 113 may reduce the determined total power demand to account for the failed equipment to lower electricity production to account for the equipment failure event such that power production is reduced at a pre-specified rate until a sustainable operating point that accommodates the loss of capacity caused by the equipment failure is determined and the operational parameters for the boiler 103, turbine 105, GPU 107 and ASU 111 are then reset in response to the new operating condition of the system caused by the equipment failure.

It should be appreciated that any of the above noted features of an electricity production system in any particular embodiment expressly discussed herein may be combined with other features or elements of other embodiments except when such a combination would be mutually exclusive or otherwise incompatible therewith as may be appreciated by those of at least ordinary skill in the art. It should also be appreciated that different variations to the above discussed embodiments may be made to meet a particular set of design criteria. For instance, the furnace of the boiler may be configured to combust fuel in multiple combustion zones. The furnace of the boiler may include only one burner or may include a plurality of spaced apart burners. As yet another example, the GPU 107 may be configured to remove different elements of the flue gas via at least one absorption mechanism, at least one adsorption mechanism, or a combination of absorption and adsorption mechanisms for performing carbon capture, or CO₂ capture, of the flue gas fed to the GPU 107. As yet another example, the conduit by which fluids are transported to different elements of the system may comprise valves, ducts, and other conduit elements. Additionally, heat exchangers, pumps, fans, and other elements may also be added to embodiments of the system to facilitate fluid movement or help control changes in the operation of the system.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of operating an electricity production system having at least one oxy-combustion boiler unit and a turbine for electricity generation, comprising:
determining a power demand for an air separation unit that supplies oxygen gas to the boiler unit and a gas processing unit that treats flows of fluid for carbon dioxide capture;
determining a total power demand for electricity production that includes the determined power demand for the air separation unit and the gas processing unit; and
coordinating operation of the air separation unit, the gas processing unit, the boiler unit, and the turbine such that power generated by the turbine provides power that meets the determined total power demand and also controls steam pressure of the turbine to a pre-specified level.

2. The method of claim 1, comprising:
selecting a mode of control from one of a boiler following mode, a turbine following mode, and a coordinated control mode for the coordinating operation of the air separation unit, the gas processing unit, the boiler unit, and the turbine based on coordinated turbine pressure control and desired turbine power.

3. The method of claim 2, wherein the pre-specified level is a pressure set point, where the boiler following mode is selected, and wherein the coordinating operation of the air separation unit, the gas processing unit, the boiler unit and the turbine comprises:
determining a turbine master demand to adjust steam turbine power generation;
determining a throttle pressure of the turbine adjacent an inlet at which steam is fed to the turbine;
determining a difference between actual power generation and a total unit load demand;
determining an operational pressure of the turbine;
determining a difference between the operational pressure of the turbine and a pressure set point;
determining a demand of the boiler unit based upon the determined throttle pressure, turbine pressure, and the difference between the operational pressure of the turbine and the pressure set point;
determining a total amount of oxygen to be separated from air by the air separation unit based on the determined demand of the boiler unit.

4. The method of claim 2, wherein the pre-specified level is a pressure set point, wherein the turbine following mode is selected, and wherein the coordinating operation of the air separation unit, the gas processing unit, the boiler unit and the turbine comprises:
determining a throttle pressure of the turbine adjacent an inlet at which steam is fed to the turbine;
determining a difference between actual power generation and total unit load demand;
determining a difference between a throttle pressure of the turbine and a pressure set point;
determining a turbine master demand based on a difference between the throttle pressure and the pressure set point;
determining a demand of the boiler unit based on a difference between the actual power generation and the total unit load demand and determining an amount of oxygen to be separated from air by the air separation unit based on the determined demand of the boiler unit.

5. The method of claim 2, wherein the coordinated control mode is selected, and wherein the coordinating operation of the air separation unit, the gas processing unit, the boiler unit and the turbine comprises:
determining a difference between a pre-specified power generation set point and an amount of power being generated by the electricity production system;
determining a difference between pressure adjacent an inlet of the turbine and a pre-specified level of pressure for the turbine;
determining a demand of the boiler unit based on (i) the determined difference between pressure adjacent an inlet of the turbine and the pre-specified level of pressure for the turbine and (ii) the determined difference between the pre-specified power generation set point and the amount of power being generated;
determining a demand of power to be generated by the turbine based on (i) the determined difference between pressure adjacent an inlet of the turbine and the pre-specified level of pressure for the turbine and (ii) the determined difference between the pre-specified power generation set point and the amount of power being generated; and
determining a total amount of oxygen to be separated from air by the air separation unit based on the determined demand of the boiler unit.

6. The method of claim 1, wherein the determining of the total power demand for electricity production that includes the determined power demand for the air separation unit and the gas processing unit comprises:
determining one of a value from operator input, a grid frequency, and an automatic dispatch demand to identify a first load amount;
verifying that the first load amount is below a first limit and is greater than a second limit, the second limit being less than the first limit; and
verifying that the first load amount corresponds to a rate change that is within a pre-specified unit load rate limit.

7. The method of claim 6, wherein the determining of the total power demand for electricity production that includes the determined power demand for the air separation unit and the gas processing unit comprises:
determining a difference between a turbine rotational speed set point and a measured rotational speed of the turbine;
adding a value corresponding to the difference between the turbine rotational speed set point and the measured rotational speed of the turbine to the first load amount when the first load amount is below the first limit, greater than the second limit and corresponds to the rate change that is within the pre-specified unit load rate limit, to identify an amount of power to be added to the determined power demand for the air separation unit and the gas processing unit to determine the total power demand.

8. The method of claim 7, wherein the determining of the total power demand for electricity production that includes the determined power demand for the air separation unit and the gas processing unit comprises:
verifying that the determined total power demand is less than a maximum amount of power that is produceable.

9. The method of claim 7, wherein the coordinating operation of the air separation unit, the gas processing unit, the boiler unit, and the turbine such that power generated by the turbine provides power that meets the determined total power demand and also controls steam pressure of the turbine to the pre-specified level comprises:
sending a first message to a boiler control system that controls operations of the boiler unit, sending a second message to an air separation unit control system that controls operations of the air separation unit, sending a third message to a gas processing unit control system that controls operations of the gas processing unit, and sending a fourth message a turbine control system that controls operation of the turbine; and
wherein the first, second, third and fourth messages identify changes to operational parameters to meet the determined total power demand.

10. The method of claim 7, comprising:
determining that equipment failure occurred;
in response to the equipment failure, reducing the determined total power demand to account for the failed equipment to lower energy production to account for the equipment failure event such that power production is reduced at a pre-specified rate.

11. A control system for an electricity production system having at least one oxy-combustion boiler unit and a turbine for electricity generation, the control system comprising:
a load management control having non-transitory memory and at least one processor communicatively connected to the memory;
a unit master station having non-transitory memory and at least one processor communicatively connected to the memory, the unit master station being communicatively connected to the load management control and being configured to be communicatively connectable to an air separation unit control that controls an air separation unit, a boiler control system that controls the boiler unit, and a turbine control system that controls the turbine;
the load management control being configured for determining an initial power demand that is supplemented by adding additional power demand for the air separation unit and a gas processing unit to determine a total power demand; and
the unit master station being configured for determining a demand for the air separation unit, boiler unit, turbine and the gas processing unit of the electricity production system based on actual power generation, total power demand, an actual pressure of a throttle of the turbine and a pre-specified set point for pressure of the throttle of the turbine for communicating operational controls to at least the air separation unit control system, boiler control system, and turbine control system.

12. The control system of claim 11, wherein the unit master station is configured for:
coordinating operation of the air separation unit, the boiler unit, and the turbine such that power generated by the turbine will provide power to meet the determined total power demand; and
controlling steam pressure of the turbine to a pre-specified level that is based on the pre-specified set point for the throttle pressure of the turbine.

13. The control system of claim 12, wherein the load management control is configured for determining the total power demand and communicating the determined total power demand to the unit master station.

14. The control system of claim 13, wherein the load management control is configured for:
determining a difference between a turbine rotational speed set point and a measured rotational speed of the turbine; and
adding a value corresponding to the difference between the turbine rotational speed set point and the measured rotational speed of the turbine to determine the total power demand.

15. The control system of claim 12, wherein the unit master station when in a first mode of operation is configured for:
determining a demand of the boiler unit based upon the determined throttle pressure, set point for the throttle, and difference between the determined throttle pressure of the turbine and the set point for the pressure of the throttle of the turbine;
determining a demand of the turbine based upon a difference between power generation and total unit load demand; and
determining a total amount of oxygen to be separated from air by the air separation unit based on the determined demand of the boiler unit.

16. The control system of claim 15, wherein the unit master station, when in a second mode of operation, is configured for:
determining a demand of the turbine based upon the determined throttle pressure, set point for the throttle pressure, and difference between the determined throttle pressure of the turbine and the set point for the throttle pressure of the throttle of the turbine; and
determining a demand of the boiler unit based on the determined demand of power to be generated by the electricity production system and determining an amount of oxygen to be supplied from the air separation unit and at least one oxygen storage device that receives and retains oxygen from the air separation unit based on the determined demand of power to be generated by the turbine.

17. The control system of claim 15, wherein the unit master station, when in a third mode of operation is configured for:
determining a difference between a pre-specified power generation set point and an amount of power being generated by the electricity production system;
determining a difference between the determined throttle pressure of the turbine and the set point for the pressure of the throttle of the turbine;
determining a demand of the boiler unit based on (i) the determined difference between the pre-specified power generation set point and the amount of power being generated by the plant and (ii) the determined difference between the determined throttle pressure of the turbine and the set point for the pressure of the throttle of the turbine;
determining a demand of power to be generated by the turbine based on (i) the determined difference between the pre-specified power generation set point and the amount of power being generated by the plant and (ii) the determined difference between the determined throttle pressure of the turbine and the set point for the pressure of the throttle of the turbine; and
determining a total amount of oxygen to be separated from air by the air separation unit based on the determined demand of the boiler unit.

18. The control system of claim 13 wherein the load management control is configured for:
determining a difference between a turbine rotational speed set point and a measured rotational speed of the turbine; and
adding a value corresponding to the difference between the turbine rotational speed set point and the measured rotational speed of the turbine to determine the total power demand.

19. An electricity production system comprising:
an oxy-combustion boiler unit;
a turbine for receiving steam from the boiler unit;
an air separation unit for feeding oxygen gas separated from air to the boiler unit for combustion of fuel in the boiler unit to form steam that is to be fed to the turbine;
a gas processing unit for processing a portion of flue gas emitted from the boiler unit to capture carbon dioxide;
a control system including a load management control having non-transitory memory and at least one processor communicatively connected to the memory and a unit master station having non-transitory memory and at least one processor communicatively connected to the memory, the unit master station being communicatively connected to the load management control and being communicatively connectable to an air separation unit control system that controls the air separation unit, a gas processing unit control system that controls the gas processing unit, a boiler control system that controls the boiler unit, and a turbine control system that controls the turbine;
the load management control being configured for determining an initial power demand that is supplemented by adding additional power demand for the air separation unit and a gas processing unit to determine a total power demand; and
the unit master station being configured for determining demands for all subsystems of the electricity production system based on the total power demand, a determined power generation, a determined pressure of a throttle of the turbine and a pre-specified set point for the pressure of the throttle of the turbine for communicating operational controls to the air separation unit control system, gas processing unit control system, boiler control system, and turbine control system.

20. The system of claim 19, wherein the unit master station is configured for:
coordinating operation of the air separation unit, the gas processing unit, the boiler unit, and the turbine such that power generated by the plant will provide power to meet the determined total power demand, and
controlling steam pressure of the turbine to a pre-specified level that is based on the pre-specified set point for the throttle of the turbine.
